(19) United States
(12) Patent Application Publication
(10) Pub. No.: US 2010/0110082 A1
(43) Pub. Date: May 6, 2010

(54) Web-Based Real-Time Animation Visualization, Creation, And Distribution

(76) Inventors: John David Myrick, San Francisco, CA (US); James Richard Myrick, El Cerrito, CA (US)

Correspondence Address: MINTZ, LEVIN, COHN, FERRIS, GLOVSKY AND POPEO, P.C, ONE FINANCIAL CENTER, BOSTON, MA, 02111, US

(21) Appl. No.: 12/610,147

(22) Filed: Oct. 30, 2009

Related U.S. Application Data
(60) Provisional application No. 61/110,437, filed on Oct. 31, 2008.

(51) Int. Cl. G06T 13/00

(52) U.S. Cl. 345/473

(57) ABSTRACT

The subject matter disclosed herein provides methods and apparatus, including computer program products, for generating animations in real-time. In one aspect there is provided a method. The method may include generating an animation by selecting one or more clips, the clips configured to include a first state representing an introduction, a second state representing an action, and a third state representing an exit, the first state and the third state including the substantially the same frame, such that the character appears in the same position in the frame and providing the generated animation for presentation at a user interface. Related systems, apparatus, methods, and/or articles are also described.

### CROSS REFERENCE TO RELATED APPLICATION

This application claims the benefit under 35 U.S.C. §119(e) of the following provisional application, which is incorporated herein by reference in its entirety: U.S. Ser. No. 61/110,437, entitled “WEB-BASED ANIMATION CREATION AND DISTRIBUTION,” filed Oct. 31, 2008 (Attorney Docket No. 38462-501 P01US).

### FIELD

This disclosure relates generally to animations.

### SUMMARY

The subject matter disclosed herein provides methods and apparatus, including computer program products, for providing real-time animations.

In one aspect there is provided a method. The method may include generating an animation by selecting one or more clips, the clips configured to include a first state representing an introduction, a second state representing an action, and a third state representing an exit, the first state and the third state including substantially the same frame, such that a character appears in the same position in the frame. The method also includes providing the generated cartoon for presentation at a user interface.

Articles are also described that comprise a tangibly embodied machine-readable medium embodying instructions that, when performed, cause one or more machines (e.g., computers, processors, etc.) to result in operations described herein. Similarly, computer systems are also described that may include a processor and a memory coupled to the processor. The memory may include one or more programs that cause the processor to perform one or more of the operations described herein.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWING

These and other aspects will now be described in detail with reference to the following drawings.

FIG. 1 illustrates a system 100 for generating animations;

FIG. 2 illustrates a process 200 for generating animations;

FIG. 3A-E depicts frames of the animation;

FIG. 4 depicts an example of the three states of a clip used in the animation;

FIG. 5 depicts an example of a layer ladder 500;

FIG. 6 depicts an example of a page presented at a user interface; and

FIG. 7 depicts a page presenting a span editor.

Like reference symbols in the various drawings indicate like elements.

### DETAILED DESCRIPTION

The subject matter described herein relates to animation and, in particular, generating high-quality computer animations using Web-based mechanisms to enable consumers (e.g., non-professional animators) to compose animation on a stage using a real-time animation visualization system. The term “animation” (also referred to as a “cartoon” as well as an “animated cartoon”) refers to a movie that is made from a series of drawings, computer graphics, or photographs of objects and that simulate movement by slight progressive changes in each frame. In some implementations, a set of assets are used to construct the animation. The term “assets” refers to objects used to compose the animations. Examples of assets include characters, props, backgrounds, and the like. Moreover, the assets may be stored to ensure that only so-called “approved” assets can be used to construct the animation. Approved assets are those assets which the user has the right to use (e.g., as a result of a license or other like grant). Using a standard Web browser, the subject matter described herein provides complex animations without having to generate any scripting or without creating individual artwork for each frame. As such, in some implementations, the subject matter described herein simplifies the process of creating animations used, for example, in an animated movie.

For example, the subject matter disclosed herein may generate animated movies by recording in real-time (e.g., at a target rate of 30 frames per second) user inputs as the user creates the animation on an image of a stage (e.g., recording mouse positions across a screen or user interface). Thus, the subject matter described herein may eliminate the setup step or the scripting actions required by other animation systems by automatically creating a script file the instant an object is brought to the stage presented at a user interface by a user. For example, in some implementations, the system records the objects X and Y location on the stage as well as any real-time transformations such as zooming and rotating. These actions are inserted into a script file and available to be modified, recorded, deleted, or edited. This process allows for visual editing of the script file, so that a non-technical user can insert multimedia from a content set onto the stage presented at a user interface, edit corresponding media and files, save the animation file, and share the resulting animated movie. In some implementations, the real-time animation visualization system allows for the creation of multimedia movies consisting of tri-loop character clips, backgrounds, props, text, audio, music, voice-overs, special effects, and other visual images.

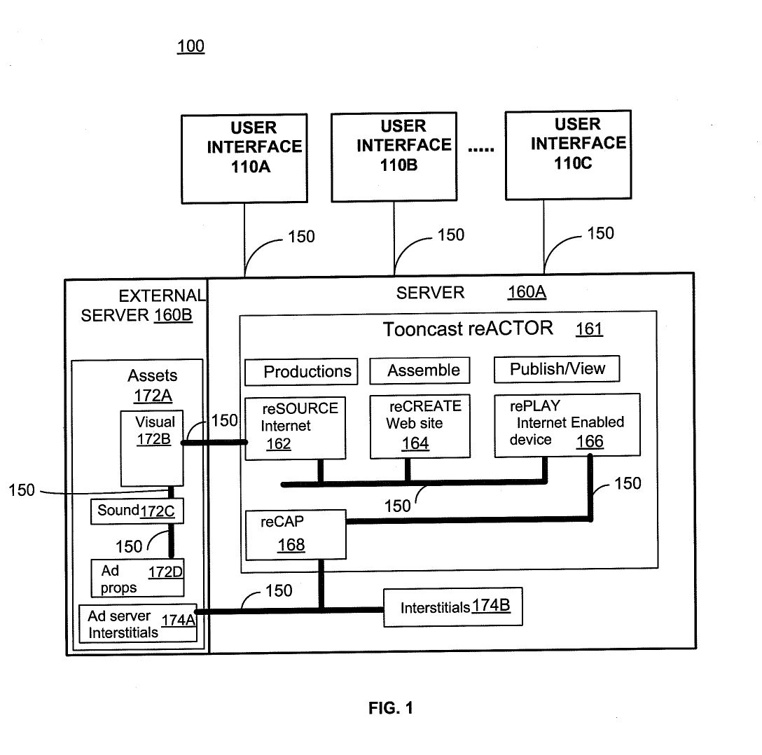

FIG. 1 depicts a system 100 configured for generating Web-based animations. System 100 includes one or more user interfaces 110A-C, one or more and servers 160A-B, all of which are coupled by a communication link 150.

Each of user interfaces 110A-C may be implemented as any type of interface mechanism for a user, such as a Web browser, a client, a smart client, and any other presentation or interface mechanism. For example, a user interface 110A may be implemented as a processor (e.g., a computer) including a Web browser to provide access to the Internet (e.g., via using communication link 150), to interface to server 160A-B, and to present (and/or interact with) content generated by server 160A, as well as the components and applications on server 160B. The user interfaces 110A-C may couple to any of the servers 160A-B.

Communication link 150 may be any type of communications mechanism and may include, alone or in any suitable combination, the Internet, a telephony-based network, a local area network (LAN), a wide area network (WAN), a dedicated intranet, wireless LAN, an intranet, a wireless network, a bus, or any other communication mechanisms. Further, any suitable combination of wired and/or wireless components and systems may provide communication link 150. Moreover, communication link 150 may be embodied using bi-directional, unidirectional, or dedicated networks. Communications through communication link 150 may also operate with standard transmission protocols, such as Transmission Control Protocol/Internet Protocol (TCP/IP), Hyper Text Transfer Protocol (HTTP), SOAP, RPC, or other protocols. In some implementations, communication link 150 is the Internet (also referred to as the Web).

Server 160A may include resource component 162, which provides a Digital Asset Management (DAM) system and a production method to enable a user of a user interface, such as user interface 110A (and/or a rights holder), to assemble and manage all the assets to be used in the reCREATE component 164 and rePLAY component 166 (which are further described below). The assets will be used in system 100 to create an animation using the reCREATE component 164 and view the animation via the rePLAY component 166.

The reSOURCE component 162 may have access to assets 172A, which may include visual assets 172B (e.g., backgrounds, clips, characters, props, scenery, and the like), sound assets 172C (e.g., music, voiceovers, special effects, sounds, and the like), and ad props 172D (e.g., sponsored products, such as a bottle including a label of a particular brand of beverage), all of which may be used to compose an animation using system 100. Interstitials may be stored at (and/or provided by) another server, such as external server 160B, although the components (e.g., assets 172A) may be located at server 160A as well. The interstitials may also be stored at (and/or provided by) interstitials 174B. The interstitials of 174A-B may include one or more of the following: a video stream, a cartoon suitable for broadcast, a static ad, a Web link, or a Web page (e.g., composed of HTML, Flash, and like Web page protocols), a picture, a banner, or an image inserted in the normal flow of a frames of animation for the purpose of advertising or promotion. Each frame may be composed of pixels or any other graphical representations. In some implementations, interstitials act in the same manner as commercials in that they are placed in-between, before, or after an animation, so as not to interfere with the animation content. In other implementations, the interstitials are embedded in the animation.

The reCREATE component 164 employs a guided method of taking pre-created assets, such as multimedia animation clips, audio, background art, and prop art in such a way as to allow a user of user interface 110A to connect to servers 160A-B to generate (e.g., compose) high-quality animated movies (also referred to herein as “Tooncasts” or cartoons) and then share the animated movies with other users having a user interface, which can couple to server 160A.

The rePLAY component 166 generates views, which can be provided to any user at a user interface, such as user interfaces 110A-C. These views (e.g., a Flash file, video, an HTML file, a JavaScript, and the like) are generated by the reCREATE component 164. The rePLAY component 166 supports a play anywhere model, which means views of animations can be delivered to online platforms (e.g., a computer coupled to the Internet), mobile platforms (e.g., iTV, IPTV, and, the like), and/or any other addressable edge device. The rePLAY component 166 may integrate with social networking for setting up and creating social networking channels among users of server 160. The rePLAY component 166 may be implemented as a Flash embedded standalone application configured to allow access by a user interface (or other component of system 100) configured with Flash. If a Web based device is not Flash capable, then the reSOURCE component 166 may convert the animation into a compatible video format that is supported by the edge device. For example, if a user interface is implemented using H.264 (e.g., an iPhone including H.264 support), the reSOURCE component 166 converts the animation to a H.264 format video for presentation at the user interface.

The reCAP component 168 may monitor servers 160A-B. For example, the reCAP component 168 collects data from components of server 160A-B (e.g., components 163-166) to analyze the activity of users coupled to server 160A-B. Specifically, the reCAP component 168 monitors what assets are being used by a user at each of the user interfaces 110A-C. The monitored activity can be mined to place ads at a user interface, add (or offer) vendor-specific assets (e.g., adding an assets for a specific brand of energy drink when a user composes a cartoon with a beverage), and the like.

In some implementations, the reCAP component 168 is used to collect and mine customer data. For example, the reCAP component 168 is used to turn raw customer data into meaningful reports, charts, billing summaries, and invoices. Moreover, a customers registered at server 160A-B may be given a username and password upon registration, which opens up a history file for that customer. From that point on, the reCAP component 168 collects a range of important information and metadata (e.g., metatags the customer data record). The types of customer data collected and metatagged for analysis includes one or more of the following: all usage activity, the number of logins, time spent on the website (i.e., server 160A), the quantity of animations created, the quantity of animations opened, the quantity of animations saved, the quantity of animations deleted, the quantity of animations viewed, and the quantity and names of the Tooncast syndications visited.

The reCAP component 168 may provide tracking of customers inside the reCREATE component 164. The reCAP component 168 may thus be able to determine what users did and when, what assets they used, touched and discarded. reCAP keeps track of animation file information, such as animation length-play back time at 30 frames per second. The reCAP component 168 tracks the types of assets users touched. For example, the reCAP component 168 may determine if users touched more props than special effects. The reCAP component 168 may track the type and kind of music used. The reCAP component 168 may track what users used the application (e.g., reACTOR 161 and/or assets 172A), which menus were used, what features were employed, and what media was used to generate an animation.

The reCAP component 168 may track advertising prop usage and interstitial play back. The reCAP component 168 may measure click thru rates and other action related responses to ads and banners. The reCAP component 168 may be used as the reporting mechanism for the generation of reports used for billing to the advertisers and sponsors for traffic, unique impression, and dwell time by measuring customer interaction with the advertising message. Moreover, the reCAP component 168 may provide data analysis tools to determine behavioral information about individual users and collections of users. The reCAP component 168 may determine user specific data, such as psychographic, demographic, and behavioral information derived from the users as well as metadata. The reCAP component 168 may then represent that user specific information in a meaningful way to provide customer feedback, product improvements, and ad targeting.

In some implementations, the reCREATE component 164 provides a so-called “real-time,” time-based editor and animation composing system. (e.g., real-time refers to a target user movement capture rate of about 30 frames per minute, 30 users x, y, z cursor locations per minute, or other capture rates as well).

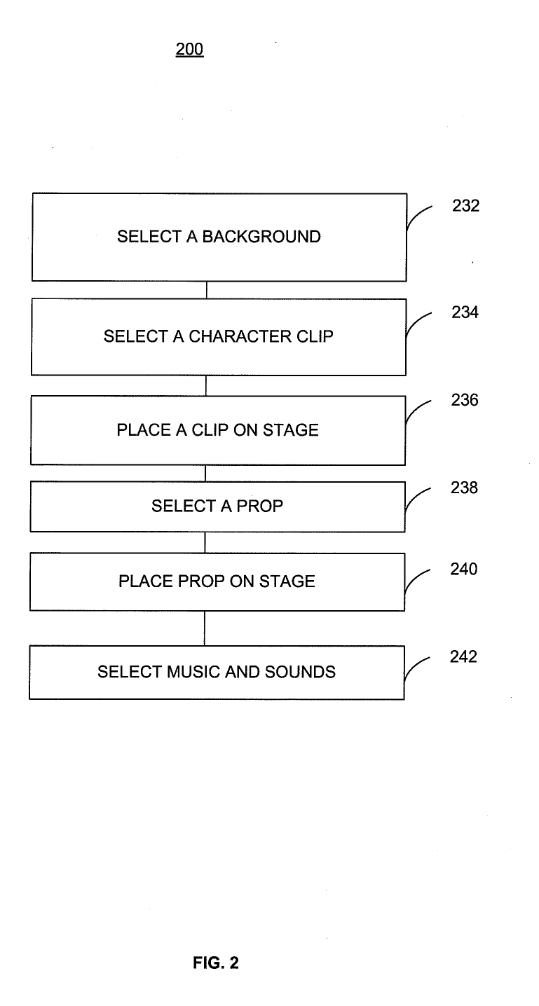

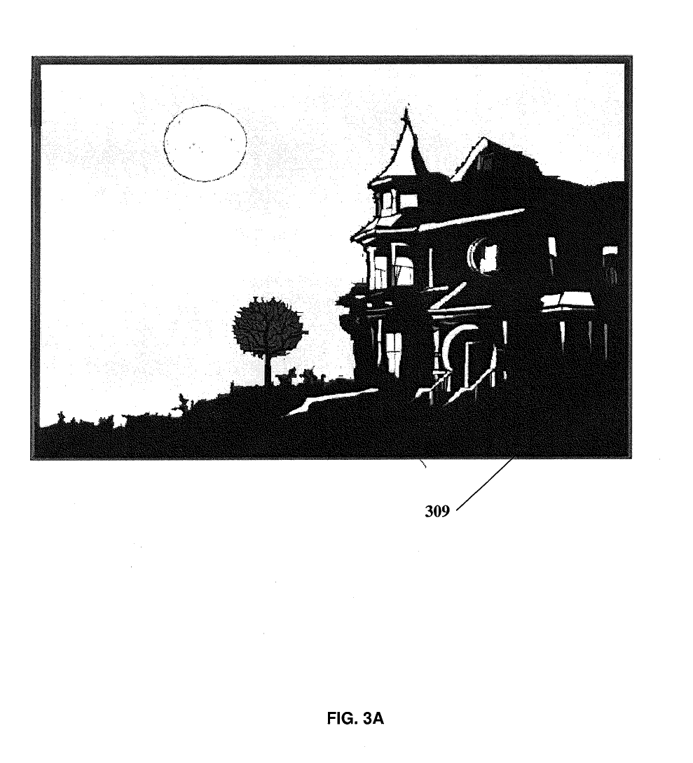

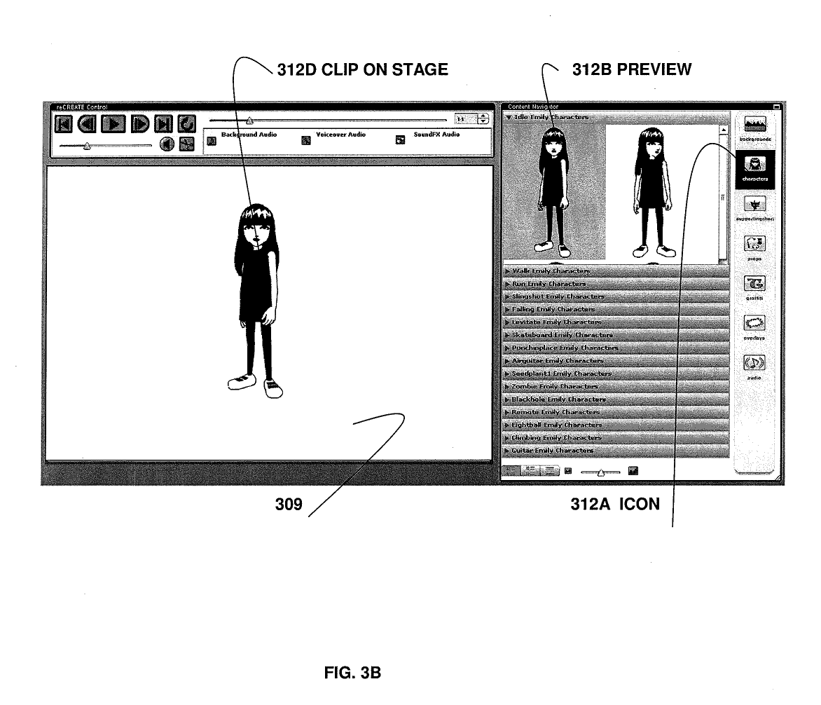

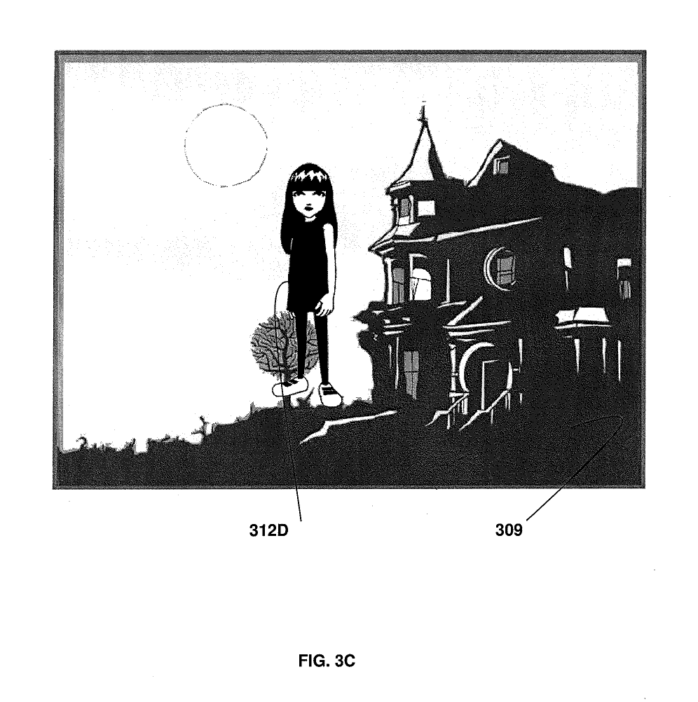

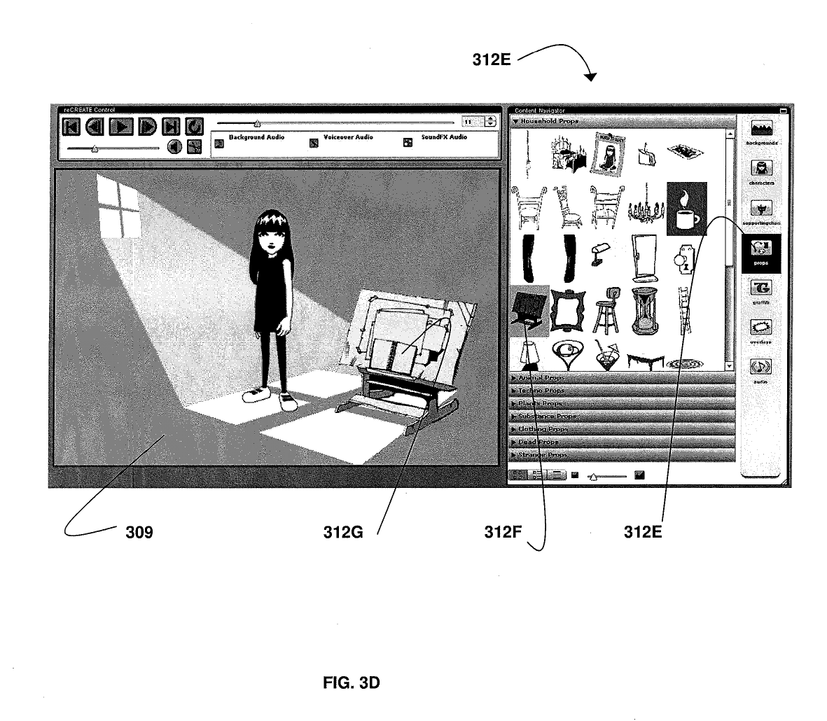

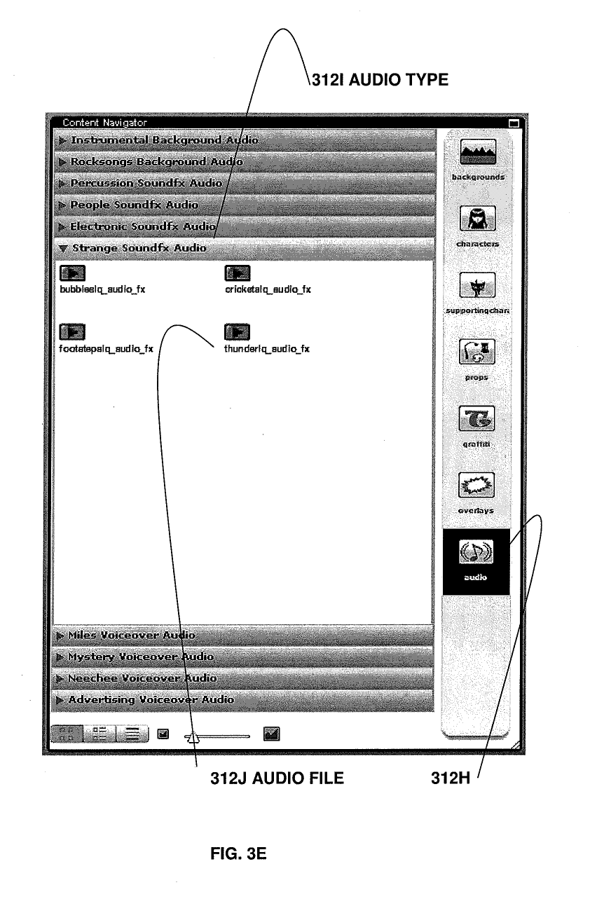

FIG. 2 depicts a process 200 for composing an animation using system 100. The description of process of 200 will refer to FIGS. 1 and 3A-3E.

In some implementations, the system 100 provides a 30 frame per second real-time recording engine as well as an integrated editor. After placing elements on an image of a stage over time, a user can fine tune and adjust the objects of the animation. This may be accomplished with a set of granular controls for element-by-element and frame-by-frame manipulation. Users may adjust timing, positioning, rotation, zoom, and presence over time to modify and polish animations that are recorded in real-time, without editing a script file. A user's animated movie edits may be accomplished with the same user interface as the real-time animation creation engine so that new layers can be recorded on top of existing layers with the same real-time visualization capabilities, referred to as real-time visual choreography.

At 232, a background is selected. The user interface 110A may be used to select from one or more backgrounds stored in the reSOURCE component 162 as a visual asset 172B. For example, a user at user interface 110A is presented with a blank stage (i.e., an image of a stage) on which to compose an animation. The user then selects via user interface 110A an initial element of the animation. For example, a user may select from among one or more icons presented to user interface 110A, each of the icons represents a background, which may be placed on the stage.

FIG. 3A depicts an example of a stage 309 selected by a user at user interface 110A.

At 234, a character clip (e.g., one or more frames) is selected. The user interfaces 110A may be used to select a character. For example, a set of icons may be presented at user interface 110A. Each of the icons may represent an animated character stored at resource component 162 as a visual asset 172B. The user interface 110A may be used to select (using, e.g., a mouse click) an animated character. Moreover, each character may have one or more clips.

FIG. 3B depicts that female character icon 312A is selected by user interface 110A and a corresponding set of clips 312B (or previews, which are also stored as visual assets 172B) for that character icon 312A.

At 236, the selected clip is placed on a stage. For example, user interface 110A may access server 160A to select a clip, which can be dragged using user interface 110A onto the background 309 (or stage).

At 238, one or more props may be selected and placed, at 240, on the background 309. The user interface 110A may access server 160A to select a prop (which can be dragged, e.g., via a mouse and user interface 110A) onto the background 309 (or stage).

FIG. 3B depicts the selected clip 312B dragged onto stage 309.

FIG. 3C depicts the resulting placement of the corresponding character 312D (including the clip) on background 309.

FIG. 3D depicts a set of props 312E. Props 312E are stored as visual assets 172B at the reSOURCE component 162, which can be accessed using user interface 110A and servers 160A-B. A prop may be selected and dragged to a position on background 309, which places the selected prop on the background.

FIG. 3D also depicts that icon 312F, which corresponds to a prop of a drawing table 312G, is placed on background 309.

At 242, music and sounds may be selected for the animation being composed. The music and sounds may be stored at sound assets 172C, so user interface 110A may access the sound assets via the reSOURCE component 162 and the reCREATE component 164. FIG. 3E depicts selecting at a user interface (e.g., one of user interfaces 110A-C) a sound asset 312H and, in particular, a strange sound special effect 3121 of thunder 312J (although other sounds may have been selected as well including instrumental background, rock, percussion, people sound effects, electronic sound effects, and the like).

When the user of user interface 110A accesses the reCREATE component 164, this allows the user to hold down a cursor presented at user interface 110A, which causes the animation to replay in real-time along the path they create, while holding the mouse button down and dragging it across the stage much in the same way one would choreograph a cartoon. The animation of the character 312D can be built up using reCREATE component 164 to perform a complex series of movements by repeating the process of selecting new animation clips (e.g., clips depicting different actions or poses, such as running, walking, standing, jumping, and the like) and string them together over time. At anytime, assets (e.g., prop art, music, voice dialog, sound, and special visual effects) can be inserted, added, or deleted from the animation. These assets can also be selected at that location in time on the stage and deleted or can be extended backward, forward, or in both directions from that location in time.

Moreover, a user at user interface 110A can repeatedly record, using reCREATE component 164, add new assets in real-time, and save the animation. This saved animation may be configured as a script file that describes the one or more assets used in the saved animation. The script file may also include a description of the user accessing system 100 and metatags associated with this animation. The saved animation file may also include call outs to other programs that verify the location of the asset, status of the ad campaign, and its use of ad props. This saved animation file and all the programs used to generate the animation are hosted on server 160A; while all the assets may be hosted on server 160B. When called by a user interface or other component, the animation may be compiled each time (e.g., on the fly when called) using rePLAY component 166, and presented on a user interface for playback.

When a user plays an animation, the file calls to action a program that verifies the existence of asset(s) at server 160B, the latest software version is being used, system 100 (or a user at a user interface) has publishing rights, the geo-location (e.g., geographic location) of the user playing the animation, status of any existing ad campaign, and if all assets are still viable or have been changed or updated.

In some implementations, rather than using a self-contained format for storing the animation, only a description file is stored. The description file lists the assets used in the animation and when each asset is used to enable a time-based recreation of the animation. This description file may make one or more calls to other programs that verify the location of the asset, status of the ad campaign, and its use of ad props. The description file and all the programs used to generate the animation generated by system 100 are hosted on server 160A. In some implementations, the animation that is viewed via the rePLAY component 166 is compiled on the fly each time to ensure the latest build, end user publishing rights, geo-location, status of ad campaign, and if all assets are still viable or have been changed or updated. As such, the animation is able to maintain viability over the lifetime of the syndication.

As each asset is placed on the stage (e.g., a background), an icon (which represents the asset) is placed in a specific location on the background as a so-called “layer” (which is further described below with respect to the Layer Ladder). Each successive asset placed after the first asset is layered in front of the previous asset. In other words, the background may be placed as a first asset and the last placed asset is placed in the foreground. Once each asset has been placed on the stage, the asset is then selectable and the ordering of these assets can be altered. Although the description herein describes the layers as spatial location in a frame(s) of a cartoon, the layers may also correspond to temporal locations as well.

As noted above, sound assets 172C may also be used. For example, using user interface 110A, a sound asset 172C can be selected, deleted, and/or placed on the background as is the case with visual assets 172B (e.g., background, props, characters, and the like). To select an audio asset 172C, a user may click on the audio icon (312H at FIG. 3E), then a user can further select a type of audio 3121 (e.g., background, theme, nature sounds, voiceover, and the like), and then a user may select an audio file 312J and drag it onto the stage where the selected audio asset can be heard when a play button is clicked.

When a character is selected as described above, the character has a complete set of clips, including animation moves, such as standing still, walking, jumping, and running. Moreover, these clips may be from a variety of, if not all, points of view. FIG. 3B depicts a set of animation moves 312B for a female character. Each of these basic animation moves has a cycle of three states, which includes an idle state (also referred to as an introduction or first state), a movement state which loops back to the idle state, and an exit state. In some implementations, the initial idle state and the exit state are the same frame of animation. This is also called tri-loop animation.

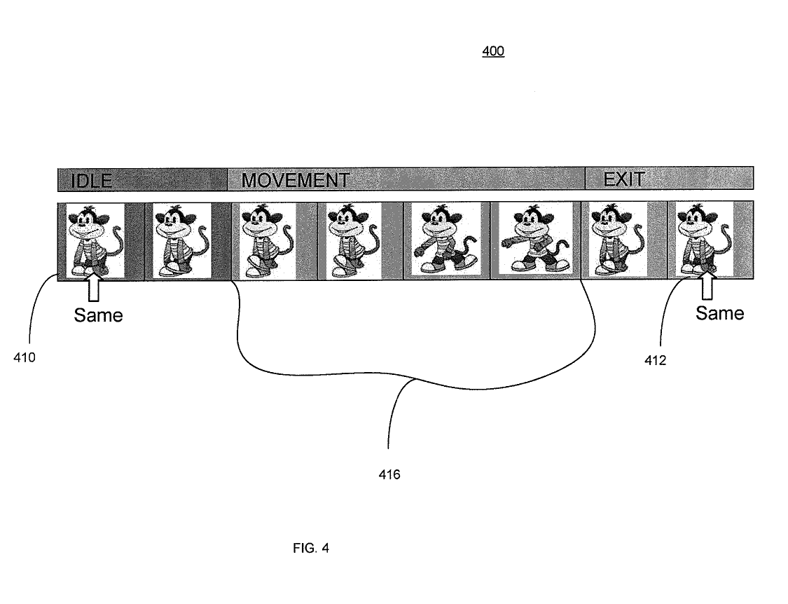

FIG. 4 depicts an example animation clip including three states or tri-loops. At frame 410, the character is in an idle state, at 412, the character performs the action, and at 416, the character exits the clip by having the same frame as in 410. This three state approach and, in particular, having the same frames at 410 and 416, allow a non-professional user to combine one or more clips (each of which uses the above-described three state approach) to provide professional looking animations. For example, the reCREATE component 164 may be used to assemble an animation, which is generated using the assets of the reSOURCE component 162. The reCREATE component then generates that animation by, for example, saving a data file (e.g., an XML file, etc), which includes the animation configured (at server 160A) for presentation that call for the assets hosted on server 160B.

Moreover, the animation may be assembled by selecting one or more clips. The clips may be configured to include a first state representing an introduction, a second state representing an action, and a third state representing an exit. Moreover, the first state and the third state may include at least one frame that appears the same. For example, the first frame of the clip and the last frame of the clip may depict a character in the same (or substantially the same) position. Moreover, the reSOURCE component 162, the reCREATE component 164, and the rePLAY component 166 may provide to communication link 150 and one or more of the user interfaces 110A-C the generated animation for presentation.

Moreover, each of the three states may be identified using metadata. For example, each of the animation moves (e.g., idle 410) may be configured to start with an introduction based on a mouse down (e.g., when a user at user interface 110B clicks on a mouse), and then the clip of the selected animation move continues to play as long as the mouse is down. However, on a mouse up (e.g., when a user at user interface 110A clicks on a mouse), the clip of the selected animation stops looping 416 and the clip of the animation move plays and records the exit animation 414. At the beginning and end of every animation move, the character may return to the same animation frame. The first frame 410 of the introduction and the last frame of the exit 416 are identical.

In some implementations, the use of the same frame at the beginning and the end of the animation clip improves the appearance of the composition of one or more animation moves, such as animation clip 400. The use of the same frame for the introduction state and exit state sequencing can be used to accommodate most clip animation moves. However, in the case of some moves (or antics), the last frame of the cycle may be unique and not return to the exact same frame as the first frame in the introduction (although it may return to about the same position of the first frame). Because of the persistence of vision phenomenon that tricks the eye into seeing motion from a rapid playback of a series of individual still frames, system 100 uses the same start and end frame technique in order to maintain the visual sensation of animated motion. Specifically, the use and implementation of the same start and end frame may play an important role, in some implementations, in the production of a professional looking animation by non-professional users through a means of selecting a number of animations from a pre-created library, such as those included in, and/or stored as, assets 172A configured using the same start and end frame.

By contrast using a pre-created animation library of assets, which does not include the same start and end frame or tri-loops, presents a visual problem at playback. This visual playback problem cannot be solved unless the animations have the exact same starting and ending frame properly prepared as described herein with respect to the tri-loops. The individual animation clips will automatically look as if they were created at once and will give the visual impression of one seamless flow from one animated move to another, when each clip end and start on the exact same frame. Described in animation terms, the use of the same start and stop frame allow for key frames and in between frames to line up in one sequence. Animators need to maintain a smooth and consistent number of individual frames played in rapid sequence of 15 frames per second or higher to achieve the impression smooth motion. Without the same start and stop frame, system 100 would not be able to maintain a smooth and even number for key frames and in between frame to achieve the persistence of vision effect of smooth animated motion at the transition point from one clip to another clip. This technique may eliminate the undesired visual look of a bunch of individual clips that are just played one after another (which would result in the animation appearing jerky and disjointed, as if frames were missing.) The use of the same frame for the introduction state and exit state allows a user at a user interface to select individual clips and put them together to create an animation sequence that appears to the human eye as smooth animated motion (e.g., perceived as smooth animated motion.) The system 100 thus provides selection to pre-created animation files designed to go together via the three states described above.

As noted, the rePLAY component 166 may be implemented to provide a viewing system independent from reCREATE component 164, which generates the presentation for user interface 110A. The rePLAY component 166 also integrates with social networking mechanisms designed to stream the playback of animations generated at server 160A and place advertising interstitials. The user at user interface 110A can access rePLAY component 166 by performing a web search (and then accessing a Web site including servers 160A-B), email (with a link to a Web site including servers 160A-B), and web links from other web sites or other users (e.g., a user of the reCREATE component 164).

In some implementations, once a user at user interface 110A has gained access to a Web site (e.g., servers 160A-B) including the rePLAY component 166, the user is presented with a control panel that includes the ability to play, stop, and volume control a Tooncast. There are two modes to view the Tooncast. The first mode is a continual play mode (which is much like the way television is viewed), in which the animations (e.g., the clips) are preselected and continue to play one after the other. The second mode is selectable play mode. The selectable play mode lets a user select which animation they wish to view. A user at user interface 110A may select an animation based on one or more of the following: a cartoon creator's name, a key word, a so-called “Top Ten” list, a so-called “Most Viewed” list, a specific character, a specific media company providing licensed assets, and other searching and filtering techniques.

In some implementations, the reSOURCE component 162 is a secure system that a user at user interface 110A employs to upload assets to be used in reACTOR 161. After assembling the selected assets, the user uploads and populates (as wells as catalogs) the assets into the appropriate locations inside the system 100 depending on the syndication, media type, and use. Each asset may be placed into discrete locations, which dictate how the assets will be displayed in the interface inside recreate component 164. All background assets may go in background folders and props go into the prop folders. The reSOURCE system 161 has preset locations and predefined rules that guide a user through the ingestion of assets.

The system 100 has the tools and methods that allow the user to review and alter one or more of the following: uploaded assets (e.g., stored at server 160B), animation file sizes, clip-to-clip play, backgrounds, props, background and prop to clip relation, individual frame animation, and audio (e.g., sound, music, voice). After reviewing all or part of the uploaded assets, the user then sends out notices to the appropriate entities (e.g., within the user's company) who have authorized access to review and approve the uploaded assets. At any point in time, an administrator of system 100 may delete (e.g., remove) assets before going live with a Tooncast syndication. Once the asset set is live, all assets are archived and removal may require a formal mechanism.

In some implementations, system 100 handles in-line advertising (e.g., ads props placed directly in an animation) differently from the other assets. The system 100 employs a plurality of props to be used in conjunction with an advertising campaign. The system 100 includes triggers (or other smart techniques) to swap a prop for an advertisement prop. For example, a user at user interface 110A may search reCAP component 168 for a soft drink bottle and a television. In this example, the search may trigger props for a specific soft drink brand and a specific television brand, both of which have been included in reSOURCE component 162 and ad props 172D.

In some implementations, the reCAP component 168 is a secure system (e.g., password protected) that the monitors system 100 and then deploys assets, such as ad props, as part of advertisement placement. In addition to providing deep analytics and statistics about the use of the system 100 (e.g., the reCREATE and rePLAY components 164 and 166), the reCAP component 168 also manages other aspects about the deployment of a Tooncast syndication. For example, a Tooncast syndication may have one brand and/or character set. An example of this would be Mickey Mouse with Minnie Mouse included in the same syndication, while Lilo & Stitch would be another and separate Tooncast syndication.

The reCAP system 168 may provide deep analytics including billing, web analytics, social media measurement, advertising, special promotions, advertising campaigns, in-line advertising props, and/or revenue reporting. The reCAP component 168 also provides decision support for new content development by customers.

In some implementations, system 100 is configured to allow a user at user interface 110 to interactively change the size and view point of a selected character being placed on the stage, i.e. scale factor and camera angle.

Moreover, the backgrounds available for an animation can range from a simple flat colored background to a complex animated background including one or more animated elements moving in the background (e.g., a sun setting to very complicated set logarithmic animations that simulate camera zooms, dolly shots, and other motion in the background).

In some implementations, system 100 is configured to provide auto unspooling of animation. For example, when an asset (e.g., an animated object) is added to a background, there is a so-called “gesture-based” unspooling that will auto unspool one animation loop, and a different gesture is used for other assets (e.g., other animated object types). In addition, manual unspooling of an animation may be used as well. Since animations can have, different lengths and some can be as long as hundreds of frames, the reCREATE component 164 is configured to provide auto unspooling of animation without the need to wait for the entire animation to play out frame by frame in real time. In most cases, the reCREATE component 164 may record in real time. However, with auto animation unspooling a user can bypass this step and speed up the creation process. This auto unspooling can be overridden by simply holding the mouse down for the exact number of frame desired. Auto insertion and unspooling may be selected based on mouse movement, such as mouse down time. For example, an auto insertion may occur in the event of a very short mouse click of generally under one half of a second, while a mouse click longer than one half of a second is treated as a manual unspool (not auto unspooling) for the animation asset. Auto unspooling may thus mainly apply to animated assets. Auto unspooling is typically treated differently for non-animated assets. For example, a second mouse click with a non-animated asset spools out a fixed amount of animation frames. This action provides the user with a fast storyboarding capability by allowing the user to lay down a number of assets in sequence without the need to hold down the mouse and manual insert the asset into the current Tooncast for the desired number of frames in real time.

In some implementations, system 100 uses a hierarchy to organize the assets placed on a background. For example, the assets may be placed in a so-called “Layer Ladder” hierarchy, such that all assets that have been placed on the stage (or background) are fully editable by simply selecting an asset in the Layer Ladder. Unlike past approaches that only present positional location of an asset on the stage, system 100 and, in particular, the reCREATE component 164 is configured to graphically display where the asset is in time (i.e., the location of an asset relative to the position of other assets in a given frame). The Layer Ladder thus allows editing of individual assets, multiple assets, and/or an entire scene. Moreover, the Layer Ladder represents all the assets in the animation—providing a more robust view of the animation over time and location (e.g., foreground to background) using icons and visual graphics. In short, the Layer Ladder shows the overall view of the animation over a span of time.

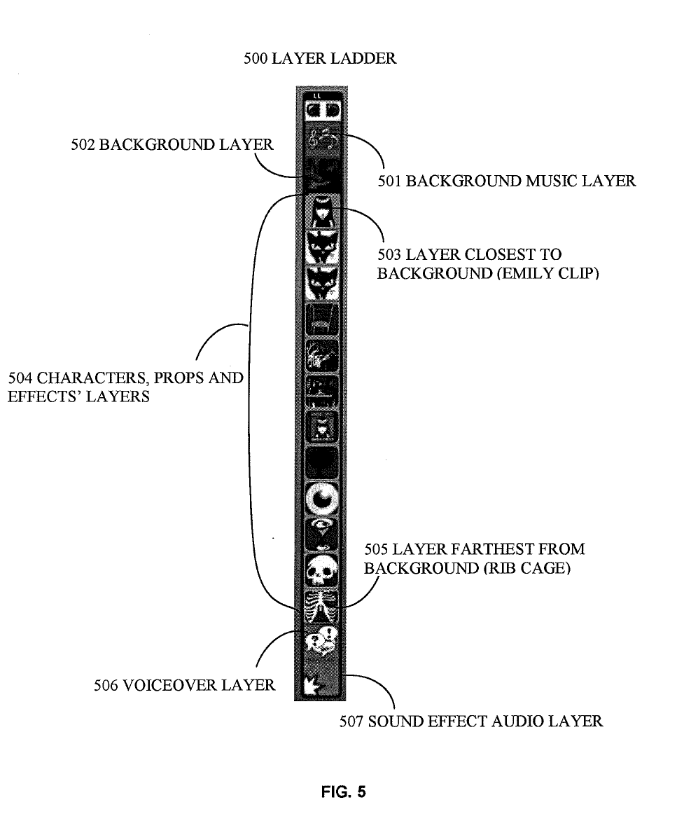

FIG. 5 depicts the Layer Ladder 500 including corresponding icons that represent each asset that has been place on the stage (e.g., stage 309) of an animation. At the top of FIG. 5 is an icon 501, which represents the background audio, and below icon 501 is icon 502, which represents the background on the stage at each instance (e.g., frame(s)) where the background is used in the animation. Below the background 501 and before the voiceover icon 506, are one or more so-called “movable” layers 504, such as characters icons, prop icons, and effect icons) 504. At the top of movable layers 504 is an icon of a female character 503, which is located on the stage closest to the background, while the rib cage 505 is a prop located farthest away from the background and therefore would be in front of the female character on the stage.

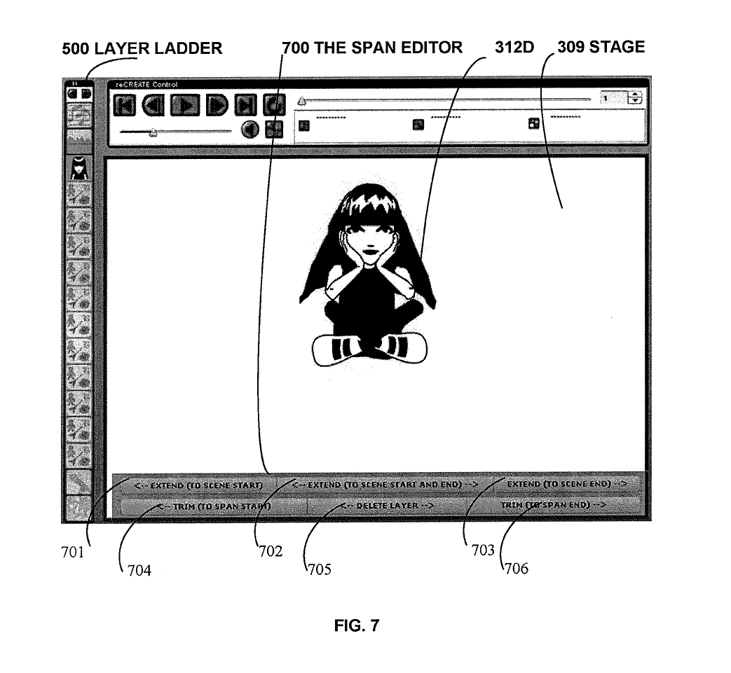

To change the order of these assets in each of the frames of the cartoon and on the Layer Ladder, a user may select (e.g., click the mouse on) the icon of the female character 503 and drag it down towards the rib cage icon 505, once over the rib cage icon 505, the user releases the mouse dragging the female character icon 503, and thus the female character is depicted on the stage in front of the rib cage and all the other asset inside the movable layer 504 will shift up one position on the Layer Ladder 500. Next, the moved asset changes its positional location with respect to all other assets throughout the frames of the animation. The background 502, the voiceover 506, and the sound effect layer 507 are typically not movable but are editable (e.g., can be replaced with another type of background, voiceover, and sound effect) by selecting (e.g., clicking on) the corresponding icon 502, 506, and 507 on the layer ladder 500. A user may click on any icon in the Layer Ladder and a Span Editor (which is described below with respect to FIG. 7) will be presented at a user interface. When an asset is selected at Layer Ladder 500, the selected asset is visually highlighted (e.g., changes color, is brighter, has a specific boundary) to distinguish the selected asset from other assets.

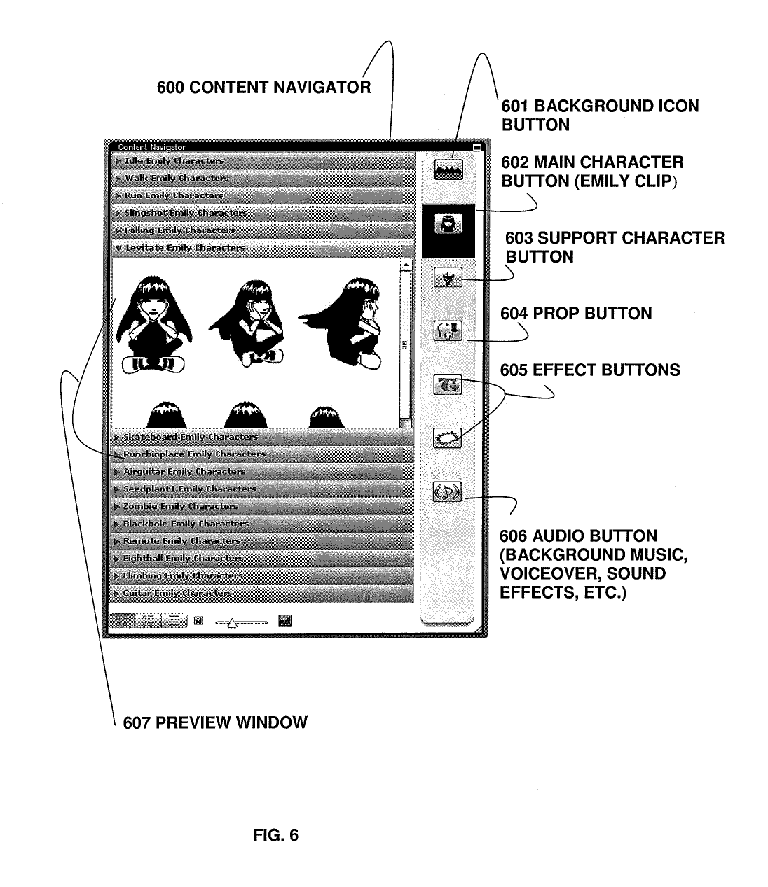

FIG. 6 depicts an example of a user interface generated by server 160A and presented at a user interface, such as user interface 110A-C.

In some implementations, system 100 is configured to interpolate between frames, adding frames, and deleting frames. Using the Layer Ladder 500 each asset (which are represented by icons 501-507) in the ladder can be selected, and once selected the Span Editor is presented as depicted at FIG. 7.

The user may edit each asset that is in the Layer Ladder 500. When extend (to scene start) 701 is selected, a user may extend the selected asset (e.g., represented by one of the icons of the layer ladder) from the current frame in which is being displayed on the stage and add that same asset from the current frame to a first frame in the animation generated by system 100. When extend (to scene start and end) 702 is selected, a user may extend the selected asset from the current frame that is being displayed on the stage and add that same asset from the current frame to a first frame and from the current frame to the last frame in the animation generated by system 100. When extend (to scene end) 703 is selected, a user may extend the selected asset from the current frame that is being displayed on the stage and add that same asset from the current frame to the last frame in the animation generated by system 100. When trim (to scene start) 704 is selected, a user may delete the selected asset from the current frame that is being displayed on the stage to the first frame while the following frames after the current frame with the same asset will not be deleted in the animation generated by system 100. When delete layer 705 is selected, a user may delete the selected asset from the current frame and all frames in the animation, thus removing it from the layer in the Layer Ladder. When trim (to scene end) 706 is selected, a user may delete the selected asset from the current frame that is being displayed on the stage and delete that same asset from the current frame to the last frame while the frames before the current frame with the same asset will not be deleted in the animation generated by system 100.

In some implementations, system 100 is configured to provide a variety of outputs. For example, when an animation is composed, the Tooncast is stored at server 160A and an email link is sent to enable access to the Tooncast. In other implementations, the composed animation is presented as an output (e.g., as a video file) when accessed as an embedded URL. Moreover, the composed animation can be shared within a social network (e.g., by sharing a URL identifying the animation). The animation may also be printed and/or presented on a variety of mechanisms (e.g., a Web site, print, a video, an edge device, and other playback and editing mechanisms).

Once an animation is generated at server 160, it is stored to enable multiple users to collaborate, build, develop, share, edit, playback, and publish the animation. Giving the end user and their friends the ability to all collaboratively develop, build, and publish an animation.

In some implementations, server 160A is configured, so that any animation that is composed is saved and played back via server 160A (e.g., copyrighted assets are saved on server 160B and are not saved on the end user's local hard drive). The user can save, open, and create an animation from a standard Web browser that is connected to the Internet. The user may also open, edit and save animations stored at server 160A, which were created by other users.

In some implementations, servers 160A-B are configured to require all users to register for a login and a password as a mechanism of securing servers 160A-B.

All end users can publish to a public or a private animation at server 160a using the Internet to provide access to other users at user interfaces 110A-C. The users of system 100 may also create a playlist to highlight their animations, special interests, friends, family, and the like.

In some implementations of user interface 110A-C, the controls are scalable and user defined to allow a user to reconfigure the presentation area of user interface 110A. For example, one or more portions of the reCREATE component may be included inside the user interfaces (e.g., a web browser), which means the reCREATE component may scale in a similar manner as the browser window is scaled.

System 100 may also be configured to include a Content Navigator. The Content Navigator provides more information about each asset and can group assets by category (e.g., assets associated with a particular character, prop, background, and the like). The Content Navigator may allow a user of user interface 100 to view assets and drag-and-drop an asset onto a stage (or background).

System 100 may also be configured to provide Auto Stitching. When this is the case, a selected asset that is placed on a stage is sized, rotated, and positioned based on the other assets already placed on the stage (or background). This Auto Stitching relieves the user from having to resize, locate, rotate, or translate a selected asset when placed onto an existing asset on the stage. The user can modify, using Auto Stitching, most media assets from their native saved state on the servers 160A-B. These modifications include changing default attributes such as scale and rotation. By allowing multiple objects to share in the same user specified attributes, the reCREATE component 164 simplifies the process of assigning multiple objects (which represents assets) to the same transformation matrix. In this manner, a user at user interface 110A can view drag a prop on a stage 309, rotate it, and make it bigger and smaller.

System 100 may also be configured to provide Auto Magic. Auto Magic is an effect that applies an algorithmic effect to an asset, a selected area of a scene or an entire scene, such as snow, fire, and rain. For example, when the Auto Magic effect of fire is applied to an animation, the animation would then have flames on or around the animation. Auto Magic works very much in the same manner as Auto Stitching but applies to programmable transformations. Instead of sharing a transformation matrix as in Auto Stitching, Auto Magic shares special effects type visual effect transformation data among objects.

In the case of Auto Stitching and Auto Magic, this is accomplished by having a data structure that allows for the passing of user modifications to default parameters in run time between objects in the program. User altered preset values may be copied and shared between media assets for a number of unified actions that can be distributed to various asset types, typically these are transformation attributes that alter the look and appearance of media assets. The data sharing can have a general purpose transformation, gating features, such as timing or over all appearance (e.g., color correction), and other types of real time or runtime image transformations on the stage of reCREATE component 164. This is an intelligent stage 309 where objects can know about each other and communicate intelligently data about their state and status.

The following provides additional description regarding Auto Stitching, Auto Magic, and the like.

Auto Stitching is an animation construction method whereby the user can drag and drop one animation asset onto another to cause the Tooncast reCREATE system to “stitch” the animation sequences together in such a way as to automatically achieve a smooth consistent animated sequence. The 2D (two-dimensional) version of this technology focuses on selecting “best fit” matching frames of animation using two separate animation assets. For example, the user drags an animated asset (such as a character animation) from the Content Navigator user interface and over an asset already placed in the Scene Stage of the Tooncast reCREATE environment. If reCREATE determines that the two assets (the one being dragged and the one being dragged over) are compatible, the system will indicate that Auto Stitching is possible using visual highlights around the drop target. When the user drops the dragged animation asset onto the highlighted target, reCREATE may perform the following functions: automatically detect which frame of the animation being dropped best matches the visible frame of the animation asset being dropped onto and automatically match transformation states (such as scaling, rotation, skewing, and the like) of the two animation assets. The use of the Auto Stitching mechanism may thus enable quick creation of sequences of animation with a smooth segue from one animation asset to the next.

In the case of three-dimensional (3D) Auto Stitching, Auto Stitching provides an animation construction method whereby the user can drag and drop one animation asset onto another to cause the Tooncast reCREATE system to “stitch” the animation sequences together in such a way as to automatically achieve a smooth consistent animated sequence. The 3D mechanism interpolates animations using a “nearest match” of animation frames from two or separate animation assets. For example, the user drags an animated asset (such as a character animation) from the Content Navigator user interface and over an asset already placed in the Scene Stage of the Tooncast reCREATE environment. If the reCREATE component determines that the two assets (e.g., the one being dragged and the one being dragged over) are compatible, the reCREATE component may indicate that Auto Stitching is possible using visual highlights around the drop target. When the user drops the dragged animation asset onto the highlighted target, reCREATE component may perform the following functions: automatically detect which frame of the animation being dropped best matches the visible frame of the animation asset being dropped onto; automatically determine of the animation sequence needed to interpolate the motion encoded in the first animation asset to the motion encoded in the second animation asset; automatically select (if required) of additional animation assets to insert between the two previously referenced animation assets in order to achieve a smoother segue of animation; and automatically match transformation states (such as scaling, rotation, skewing and the like) of all of the animation assets used in the process. As such, the use of the Auto Stitching mechanism enables a user to quickly create sequences of animation with a smooth segue from one animation asset to the next while tracking changes to the animation based on camera angle switches, motion paths and the like.

In some implementations, the system includes an intelligent directional behavior (IDB) mechanism, which describes how the system automatically swaps into and out of the stage animation loops based on the user's mouse movement, such as direction and velocity. For example if the user moves the mouse to the right, the character starts walking to the right. If the user moves the mouse faster, the character will start to run. If the user changes direction and now moves the mouse in the opposite direction, the character will instantly switch the point of view pose and now look as if it is walking or running in the opposite direction, say to the left. This is a variation of auto loop stitching because the system is intelligent enough to recognize directions and insert the correct animation at the right time. This greatly simplifies the process of stitching together different character clips in sequence to achieve the same result of the character transitioning from walking to the right, running, changing direction and running in the opposite direction. With IDB, this sequence of animation clips is draw from the asset library automatically and the user does not need to open the assets and select them one by one. The auto loop stitching is achieved by IDB.

In some implementations, the system 100 includes an Auto Transform mechanism that depicts special effects as objects in the Content Navigator (see e.g., FIGS. 3E and 3F) user interface. The objects include descriptions of sequences of transformations of a specific visual asset in a Tooncast. For example, the Content Navigator may provide a special effects category of content, which will be subdivided into groups. One of these groups is Auto Transform. The Auto Transform group may include a collection of visual tiles, each of which represents a pre-constructed Auto Transform asset. An Auto Transform asset describes the transformation of one or more object properties over time. Such properties will include color, x and y positioning, alpha blending level, rotation, scaling, skewing and the like. The tile which represents a particular Auto Transform special effect shows an animated preview of the combination of transformations that are encoded into that particular Auto Transform asset.

When the user drags an Auto Transform tile from the Content Navigator and drops it onto an asset already placed in the Scene Stage of the Tooncast reCREATE environment, the user will be presented with a dialog. The dialog will present the user with the option of modifying some or all of the transformations which have been pre-set in the Auto Transform asset before those transformations are applied to the asset that the Auto Transform is being applied to. After the user confirms their selection, the Auto Transform will be applied to the asset, replacing any previously applied transformations.

In some implementations, the system 100 includes an Auto Magic special effects mechanism, Auto Magic is an enhancement to and possible transformation of a visual object's pixels over time. As noted above, these transformations can create the appearance of fire, glows, explosions, shattering, shadows and the like. The Content Navigator may include a special effects category of content, which will be subdivided into groups. One of these groups is Auto Magic, which will include a collection of visual tiles (e.g., icons, etc). Each of these tiles will represent a pre-constructed Auto Magic asset. An Auto Magic asset describes the transformation of a visual object's pixels over time in order to achieve a specific visual effect. Such visual effects may include fire, glow, exploding, shattering, shadows, melting and the like. The tile represents a particular Auto Magic special effect will show an animated preview of the visual effect that is encoded into that particular Auto Magic asset. When the user drags an Auto Magic tile from the Content Navigator and drops it onto an asset already placed in the Scene Stage of the Tooncast reCREATE environment, the user is presented with a dialog. The dialog will present the user with the option of modifying some or all of the settings which have been pre-set in the Auto Magic asset before the visual effect encoded into that Auto Magic asset is applied to the asset. After the user confirms their selection, the Auto Magic special effect will be applied to the asset.

An Auto Magic prop mechanism may also be included in some implementations of system 100. The Auto Magic prop is a transformation of pixels of screen regions over time. These transformations can create the appearance of fire, glows, explosions, shattering, shadows and the like. The Content Navigator may provide a props category of content which is subdivided into groups, one of which is Auto Magic. In the Auto Magic group, there is a collection of visual tiles. Each of these tiles represents a pre-constructed Auto Magic prop. An Auto Magic prop describes the transformation of a screen region's pixels over time in order to achieve a specific visual effect. Such visual effects will include fire, glow, exploding, shattering, shadows, melting and the like. The tile which represents a particular Auto Magic prop will show an animated preview of the visual effect that is encoded into that particular Auto Magic prop asset. When the user drags an Auto Magic prop tile from the Content Navigator and drops it into the Scene Stage of the reCREATE environment, the user will be presented with a dialog. The dialog will present the user with the option of modifying some or all of the settings which have been pre-set in the Auto Magic prop asset before the visual effect encoded into that Auto Magic asset is applied. After the user confirms their selection, they will then be prompted to select a region of the screen to which that Auto Magic special effect will be applied. After the user completes their selection of the screen region, they are done. When the Tooncast is played, the region that was selected will be transformed and the specified visual effect with its settings will be applied. As each frame of the Tooncast animation is rendered, this region may change to reflect animation in the visual effect.

Moreover, a script file may be used as well to define actions on a computer screen or stage. Scripts may be used to position elements in time and space and to control the visual display on the computer screen at playback. ReCREATE may be used to remove the scripting step from multimedia authoring.

A timeline is associated with multimedia authoring in order to position events, media and elements at specific frames in a movie. The real-time animation visualization techniques described herein may be used to bypass a scripting step at the authoring stage by recording what a person does with events, media and elements on the computer screen stage as they are happening in real-time. By rapidly capturing a person's mouse position (e.g., a cursor position) and movements 30 times a second and then automatically inserting the x, y and z location of the element on the stage where the person had positioned it, the reCREATE component creates a timeline automatically. In essence, the reCREATE component provides a what you see is what you get for animation creation, where a person moves an element on the stage is inserted into a timeline based on a 30 frame per second playback rate. The reCREATE component is configured to allow for the user to select objects, media and elements and to create and edit the script file and timeline visually.

Metadata may be included in a description representative of the animation. For example, an animation may include as metadata one or more of the following: a creator of the asset, a data, a user using the asset, a song name, a song length, a length of clip (e.g., of an animation move), an identifier (e.g., a name) of a character or Syndication name, an identifier of a prop, and an identifier of a background name.

The subject matter described herein may be embodied in systems, apparatus, methods, and/or articles depending on the desired configuration. In particular, various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications, applications, components, or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Wherever possible, the same reference numbers will be used throughout the drawings to refer to the same or like parts.

Although a few variations have been described in detail above, other modifications or additions are possible. In particular, further features and/or variations may be provided in addition to those set forth herein. For example, the implementations described above may be directed to various combinations and subcombinations of the disclosed features and/or combinations and subcombinations of several further features disclosed above. In addition, the logic flow depicted in the accompanying figures and/or described herein do not require the particular order shown, or sequential order, to achieve desirable results. Other embodiments may be within the scope of the following claims.

As used herein, the term “user” may refer to any entity including a person or a computer. As used herein a “set” can refer to zero or more items.

The foregoing description is intended to illustrate but not to limit the scope of the invention, which is defined by the scope of the appended claims. Other embodiments are within the scope of the following claims.

What is claimed:

1. A computer-readable medium containing instructions to configure a processor to perform a method, the method comprising:
generating an animation by selecting one or more clips including a plurality of frames, the clips configured to include a first state representing an introduction, a second state representing an action, and a third state representing an exit, the first state and the third state each including substantially the same frame, such that an object appears in the same position in each of the same frames; and
providing the generated cartoon for presentation at a user interface.

2. The computer-readable medium of claim 1, wherein the object comprises a character.

3. The computer-readable medium of claim 1 further comprising:
generating a layer ladder representing one or more objects included in the generated cartoon.

4. The computer-readable medium of claim 3, wherein the layer ladder depicts a plurality of tiles corresponding to a plurality of objects included within at least one frame of the generated cartoon, wherein position information of the plurality of tiles represents where in the at least one frame of the generated cartoon the corresponding one or more objects are located.

5. The computer-readable medium of claim 1, wherein substantially the same frame comprises at least one frame common to both the first and third states.

6. The computer-readable medium of claim 1, wherein the first, second, and third states comprise a tri-loop, and wherein the generated cartoon is provided to a processor for access by a social networking website.

7. A system comprising:
at least one processor;
at least one memory, wherein the at least one processor and the at least one memory are configured to provide at least the following:
generating an animation by selecting one or more clips including a plurality of frames, the clips configured to include a first state representing an introduction, a second state representing an action, and a third state representing an exit, the first state and the third state each including substantially the same frame, such that an object appears in the same position in each of the same frames; and
providing the generated cartoon for presentation at a user interface.

8. The system of claim 7, wherein the object comprises a character.

9. The system of claim 7 further comprising:
generating a layer ladder representing one or more objects included in the generated cartoon.

10. The system of claim 9, wherein the layer ladder depicts a plurality of tiles corresponding to a plurality of objects included within at least one frame of the generated cartoon, wherein position information of the plurality of tiles represents where in the at least one frame of the generated cartoon the corresponding one or more objects are located.

11. The system of claim 7, wherein substantially the same frame comprises at least one frame common to both the first and third states.

12. The system of claim 7, wherein the first, second, and third states comprise a tri-loop.

13. A method comprising:
generating an animation by selecting one or more clips including a plurality of frames, the clips configured to include a first state representing an introduction, a second state representing an action, and a third state representing an exit, the first state and the third state each including substantially the same frame, such that an object appears in the same position in each of the same frames; and
providing the generated cartoon for presentation at a user interface.

14. The method of claim 13, wherein the object comprises a character.

15. The method of claim 13 further comprising:
generating a layer ladder representing one or more objects included in the generated cartoon.

16. The method of claim 15, wherein the layer ladder depicts a plurality of tiles corresponding to a plurality of objects included within at least one frame of the generated cartoon, wherein position information of the plurality of tiles represents where in the at least one frame of the generated cartoon the corresponding one or more objects are located.

17. The method of claim 13, wherein substantially the same frame comprises at least one frame common to both the first and third states.

18. The method of claim 13, wherein the first, second, and third states comprise a tri-loop.

19. The method of claim 13 further comprising:
providing the generated cartoon to a processor for access by a social networking website.
